(19) United States
(12) Patent Application Publication
(10) Pub. No.: US 2026/0154047 A1
(43) Pub. Date: Jun. 4, 2026

(54) SPATIAL DISPLAY OF REGISTER TRANSFER LEVEL (RTL) CODE ON AN INFINITE VISUAL CANVAS

(71) Applicant: Singularity Dynamics Private Limited, Bangalore (IN)

(72) Inventor: Harish Kumar, Bangalore (IN)

(21) Appl. No.: 19/404,027

(22) Filed: Dec. 1, 2025

Related U.S. Application Data
(60) Provisional application No. 63/726,343, filed on Nov. 29, 2024.

(51) Int. Cl. G06F 8/34

(52) U.S. Cl. CPC G06F 8/34

(57) ABSTRACT

Disclosed subject matter relates to verification and debugging tool and method for providing spatial display of Register Transfer Level (RTL) code on a visual display. The verification and debugging tool includes an input interface configured to receive RTL code in a Hardware Description Language (HDL). Further, the verification and debugging tool includes an RTL parser configured to parse the RTL code, and generate an abstract syntax tree representing the syntactic structure of the RTL code. Thereafter, the verification and debugging tool includes a graph converter adapted to convert the abstract syntax tree into an RTL directed graph. Finally, the verification and debugging tool includes a visual display configured to display the RTL directed graph. The visual display simultaneously allows visualization of multiple code blocks and corresponding interconnections.

### CROSS-REFERENCE TO RELATED APPLICATIONS

The present application claims the benefit of priority to U.S. Provisional Application No. 63/726,343, filed on November 29, 2024; the contents of which are hereby incorporated by reference herein in their entirety.

### TECHNICAL FIELD

The present disclosure relates to electronic design. Particularly, the present disclosure relates to a technique of providing spatial display of Register Transfer Level (RTL) code on a visual display.

### BACKGROUND

Modern electronic design is typically performed with Computer-Aided Design (CAD) tools or Electronic Design Automation (EDA) systems. To design an Integrated Circuit (IC) device, a designer first creates high-level behavior descriptions of the IC device using a hardware description language (HDL) such as Verilog and VHDL. As the complexity of the IC devices is growing exponentially due to changes such as shrinking in size of the IC chips and integration of more functionality onto a single IC chip, the behavioral descriptions of the devices are also becoming complex due to a large number of code blocks written in HDL for the IC chips.

There may be errors or problems in the written code blocks, which may be identified and resolved using verification and debugging tools. However, the existing verification and debugging tools provide only a limited window space to visualize the RTL code and thus only a few code blocks out of a large number of code blocks are visible at a time in code window. This makes the process of debugging very complex and time consuming.

Therefore, there is a need for a verification and debugging tool that can provide a global visual view of the RTL code blocks along with data and control flow. Also, there is a need for a verification and debugging tool that can provide a view of connections between the RTL code blocks.

The information disclosed in this background of the disclosure section is only for enhancement of understanding of the general background of the invention and should not be taken as an acknowledgement or any form of suggestion that this information forms the prior art already known to a person skilled in the art.

### SUMMARY

Disclosed herein is a verification and debugging tool for Register Transfer Level (RTL) code. The verification and debugging tool comprises an input interface configured to receive RTL code in a Hardware Description Language (HDL). Further, the verification and debugging tool comprises an RTL parser configured to parse the RTL code, and generate an abstract syntax tree representing the syntactic structure of the RTL code. Thereafter, the verification and debugging tool comprises a graph converter adapted to convert the abstract syntax tree into an RTL directed graph. The RTL directed graph comprises plurality of code blocks. Each of the plurality of code blocks is represented as a node, and connections between the node indicate data flow in both upstream and downstream directions. Finally, the verification and debugging tool comprises a visual display configured to display the RTL directed graph. The visual display simultaneously allows visualization of multiple code blocks and corresponding interconnections.

Further, disclosed herein is a method of providing spatial display of Register Transfer Level (RTL) code on a visual display. The method includes receiving RTL code in a Hardware Description Language (HDL). Further, the method includes parsing the RTL code, and generating an abstract syntax tree representing the syntactic structure of the RTL code. Thereafter, the method includes converting the abstract syntax tree into an RTL directed graph. The RTL directed graph comprises plurality of code blocks. Each of the plurality of code blocks is represented as a node, and connections between the node indicate data flow in both upstream and downstream directions. Finally, the method includes displaying the RTL directed graph. Multiple code blocks and corresponding interconnections are visualized simultaneously.

Furthermore, the present disclosure relates to a non-transitory computer readable medium including instructions stored thereon that when processed by at least one processor, cause a verification and debugging tool to perform operations comprising receiving RTL code in a Hardware Description Language (HDL). Further, the instructions cause the processor to parse the RTL code, and generate an abstract syntax tree representing the syntactic structure of the RTL code. Thereafter, the instructions cause the processor to convert the abstract syntax tree into an RTL directed graph. The RTL directed graph comprises plurality of code blocks. Each of the plurality of code blocks is represented as a node, and connections between the node indicate data flow in both upstream and downstream directions. Finally, the instructions cause the processor to display the RTL directed graph. Multiple code blocks and corresponding interconnections are visualized simultaneously.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1A and 1B illustrate a depiction of an existing debugging tool;

FIG. 2 shows an exemplary environment of providing spatial display of Register Transfer Level (RTL) code on a visual display, in accordance with some embodiments of the present disclosure;

FIG. 3 shows an exemplary illustration of the directed graph, in accordance with an exemplary embodiment of the present disclosure;

FIG. 4 shows a flowchart illustrating method of providing spatial display of Register Transfer Level (RTL) code on a visual display, in accordance with some embodiments of the present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or identity server proceeded by “comprises… a” does not, without more constraints, preclude the existence of other elements or additional elements in the system or method.

The terms like “at least one” and “one or more” may be used interchangeably throughout the description.

The terms like “verification and debugging tool”, “verification tool”, “debugging tool” and “tool” may be used interchangeably throughout the description.

The terms like “RTL code” and “code” may be used interchangeably throughout the description.

The terms like “circuit designer” and “designer” may be used interchangeably throughout the description.

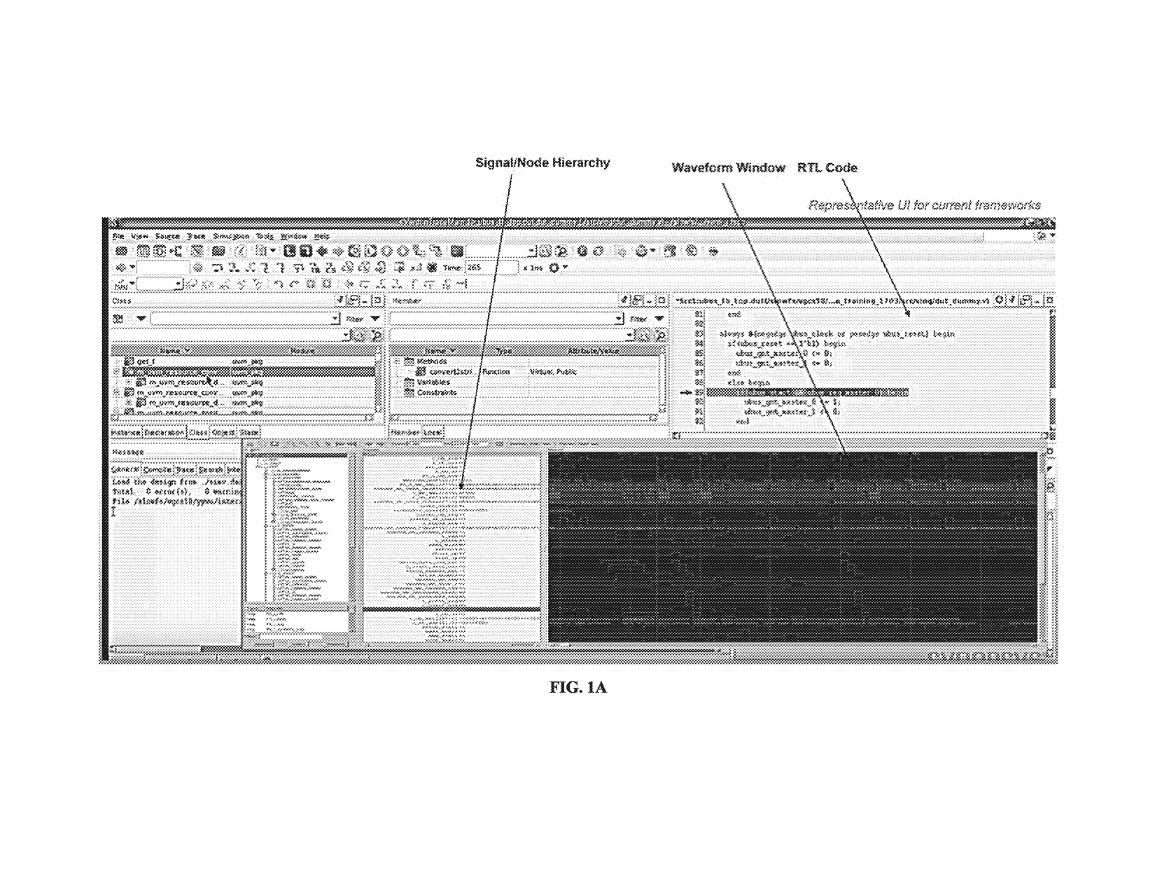

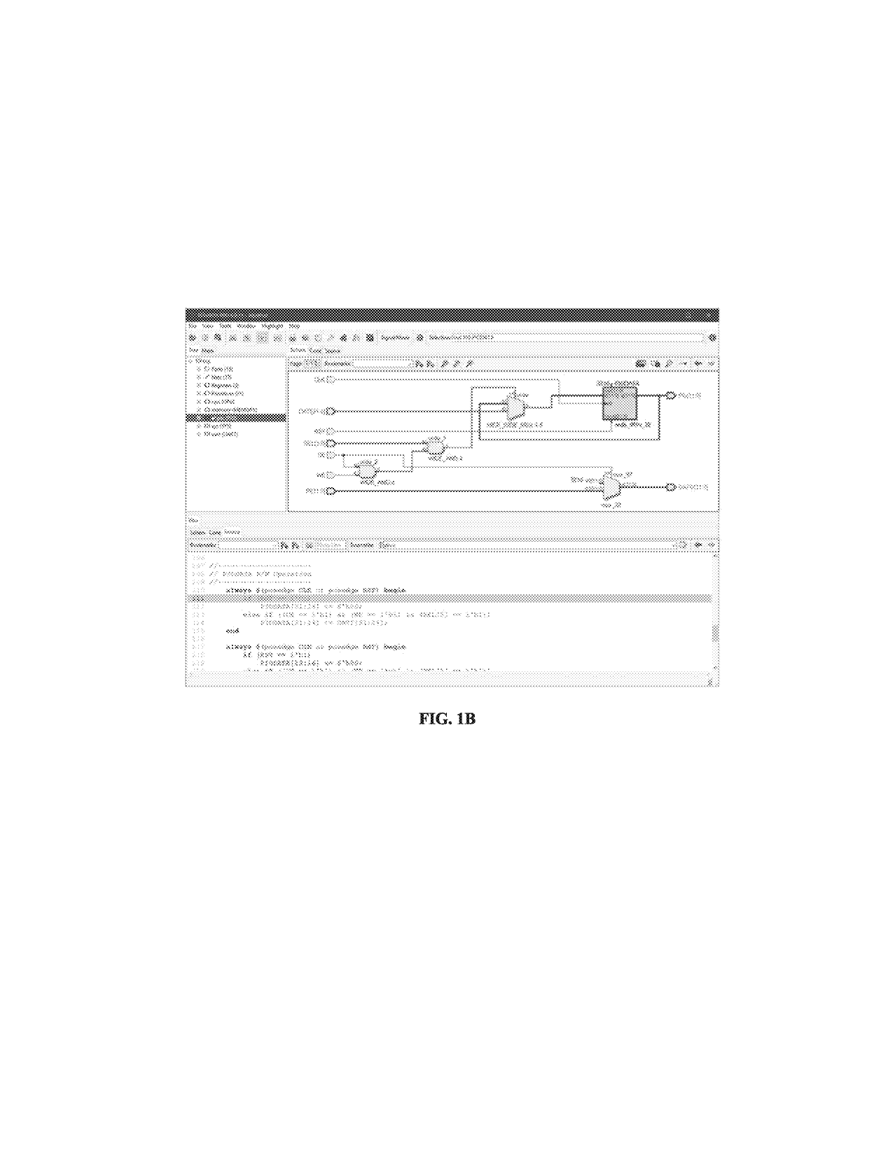

Existing debugging tools are based on the same basic idea of debug framework and have several limitations. Few of the limitations of the existing debugging tools are that the debugging tools do not provide a global visual view of how logic is structured and how data and control flow is structured for an RTL code. Further, the existing debugging tools provide limited window of visibility into the RTL code. Also, in the existing debugging tools the signal addition is limited e.g., only one signal or a group of signal addition at a time is provided. FIG. 1A-1B disclose existing debugging tools. Referring to FIG. 1A, the screen of the tool includes multiple windows which makes it difficult for a designer to understand the flow of signals. Accordingly, such presentation consumes significant time of the designers while understanding the signal flow. Referring to FIG. 1B, only one or a few RTL blocks can be displayed and the tool displays symbolic views of the RTL with connectivity only and not RTL code itself. The designer may have to individually refer each window to resolve any bugs encountered during compilation/testing. Therefore, the existing tools consume significant time to cater debugging operations which may affect the time consumed in the overall development cycle of the code.

The present disclosure relates to a verification and debugging tool that provides a global visual view of Register Transfer Level (RTL) code written on the tool. The RTL code is a coding style used in digital system design and computer engineering and written using hardware description language (HDL) like Verilog or VHDL. The RTL code includes one or more code blocks that describe how data is transformed during its flow from one register to another. A code block is an independent piece of the RTL code started and terminated by delimiters such as BEGIN and END, or semicolon in case of an assign statement, etc. The transformation of data is performed by combinational logic that exists between the registers. The operation of the RTL code is verified by using the verification tool and if errors or problems arise in the code during its operation, the problems are solved or debugged by the debugging tool. The tool may convert the RTL code into an abstract syntax tree and then convert the abstract syntax tree into an RTL directed graph. The present disclosure describes the tool which provides the global visual view of all the code blocks of the RTL code in the form of the directed graph.

The present disclosure displays the RTL code itself on the screen along with interconnection details (i.e. how various modules of the code are connected with one another). Further, unlike the existing tools, the present disclosure considers the screen as an infinite canvas on which as many RTL code blocks as desired along with their connectivity may be displayed simultaneously. This gives the designer a global view of all the RTL code required for analysis along with their connectivity. This leads to dramatically higher productivity.

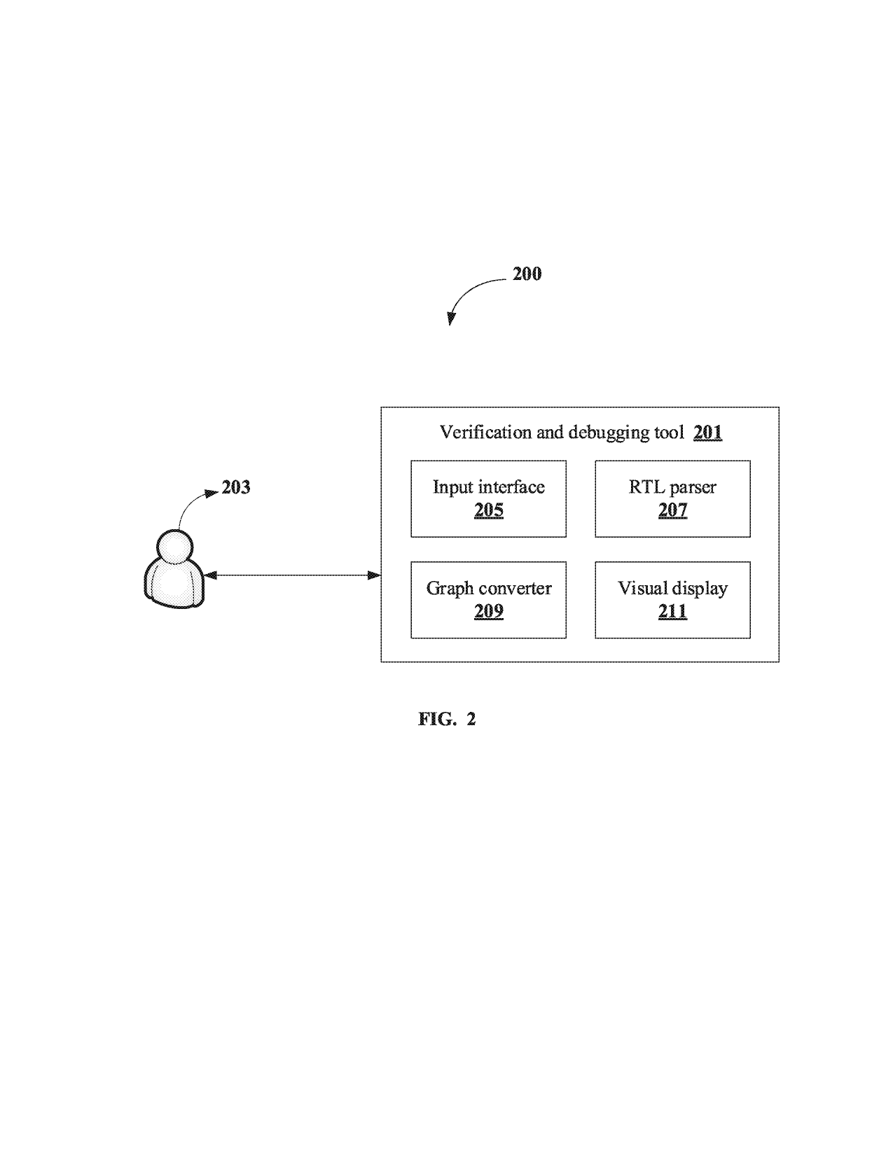

FIG. 2 shows an exemplary environment of providing spatial display of Register Transfer Level (RTL) code on a visual display, in accordance with some embodiments of the present disclosure.

Exemplary environment 200 includes a verification and debugging tool 201 and a user 203. The verification and debugging tool 201 may include an input interface 205, a RTL parser 207, a graph converter 209, and a visual display 211. The user 203 may interact with the verification and debugging tool 201 using the input interface 205 and the visual display 211. The input interface 205 may include, without limitation, keyboards, mice, touchscreens, and the like, which allow direct user interaction. The input interface 205 may also receive input from any sources provided by the user 203. As an example, the input interface 205 may receive input from Uniform Resource Locator (URL). The output may be displayed on the visual display 211. As an example, the visual display 211 may include, without limitation, an electronic screen, a touchscreen and the like, which allows display of the output. In an embodiment, the verification and debugging tool 201 may be a computing device. As an example, the computing device may be any device used by the user 203 such as, but is not limited to, mobile phones, smartphones, laptops, and Personal Computers (PCs). In some embodiments, the verification and debugging tool 201 may be configured within the computing device (not shown in figure).

In an embodiment, the input interface 205 may be configured to receive RTL code in a Hardware Description Language (HDL) from the user 203. The HDLs may include, without limitation, at least one of Verilog and VHSIC Hardware Description Language (VHDL). As an example, the user 203 may be a circuit designer. The RTL code may describe behavior and component connections of a circuit such as an Integrated Circuit (IC). The RTL code may include one or more code blocks describing the operations of one or more entities/components of the circuit. In an embodiment, the input interface 205 may be further configured to validate syntax of the RTL code using known techniques. If syntax error is detected, the syntax error may be displayed on the visual display 211 allowing the user 203 to edit the RTL code to rectify the syntax error. The input interface 205 may also detect any error which may affect execution of the RTL code.

In an embodiment, upon receiving the RTL code, the RTL parser 207 may be configured to parse the RTL code. In an embodiment, the RTL parser 207 may parse the RTL code by performing lexical and syntactic analysis to identify structural elements such as modules, signals, assignments, and control statements. Based on this analysis, the RTL parser 207 may generate an Abstract Syntax Tree (AST) that represents the hierarchical syntactic structure of the RTL code. The AST may include nodes corresponding to language constructs and captures parent-child relationships between statements, thereby providing a structured and unambiguous representation of the RTL code for subsequent transformation into an RTL directed graph.

In an embodiment, upon generating the AST, the graph converter 209 may be configured to convert the AST into the RTL directed graph. In an embodiment, each node of the RTL directed graph may include, without limitation, at least one of a forward pointer to nodes for which the current node forms an input, and a backward pointer to nodes from which the current node receives an input. The graph converter 209 may be further configured to represent signals of the RTL code as vertices of the RTL directed graph. The graph converter 209 may also provide one or more customizable display options for the RTL directed graph. The customizable options may enable the user 203 to modify the visual representation of the RTL directed graph to suit specific debugging or analysis requirements. The one or more customizable display options may include, without limitation, color coding for different signal types or logic states, adjustable node sizes to emphasize critical modules, selectable layers for viewing control flow or data flow independently, and variable line thickness or styles to indicate signal width or type. Additional customization may include zoom functionality for detailed inspection of individual nodes, dynamic visual effects to represent changes in signal values over time, and grouping of related nodes into functional sections. These customizable display options enhance clarity, improve navigation within complex RTL designs, and facilitate efficient identification of design issues during verification and debugging. In some embodiments, the RTL directed graph may be configured to display at least one of control flow and data flow. At least one of the control flow and the data flow may be displayed in a visually distinguishable manner. The visual distinction between the control flow and the data flow may be obtained using one of different arrow styles or different colors. In other words, the visual distinction between control flow and data flow within the RTL directed graph is achieved through the use of differentiated graphical indicators. In one embodiment, the distinction is provided by employing different arrow styles, such as solid arrows for data flow and dashed arrows for control flow, or by varying arrowhead shapes to represent signal types, but is not limited thereto. Alternatively, the distinction may be implemented using different colors for the respective flows, enabling clear and intuitive identification of control signals versus data paths. These visual differentiation techniques enhance the readability of complex RTL designs and facilitate efficient debugging and verification by allowing users to quickly interpret the nature of each connection within the graph.

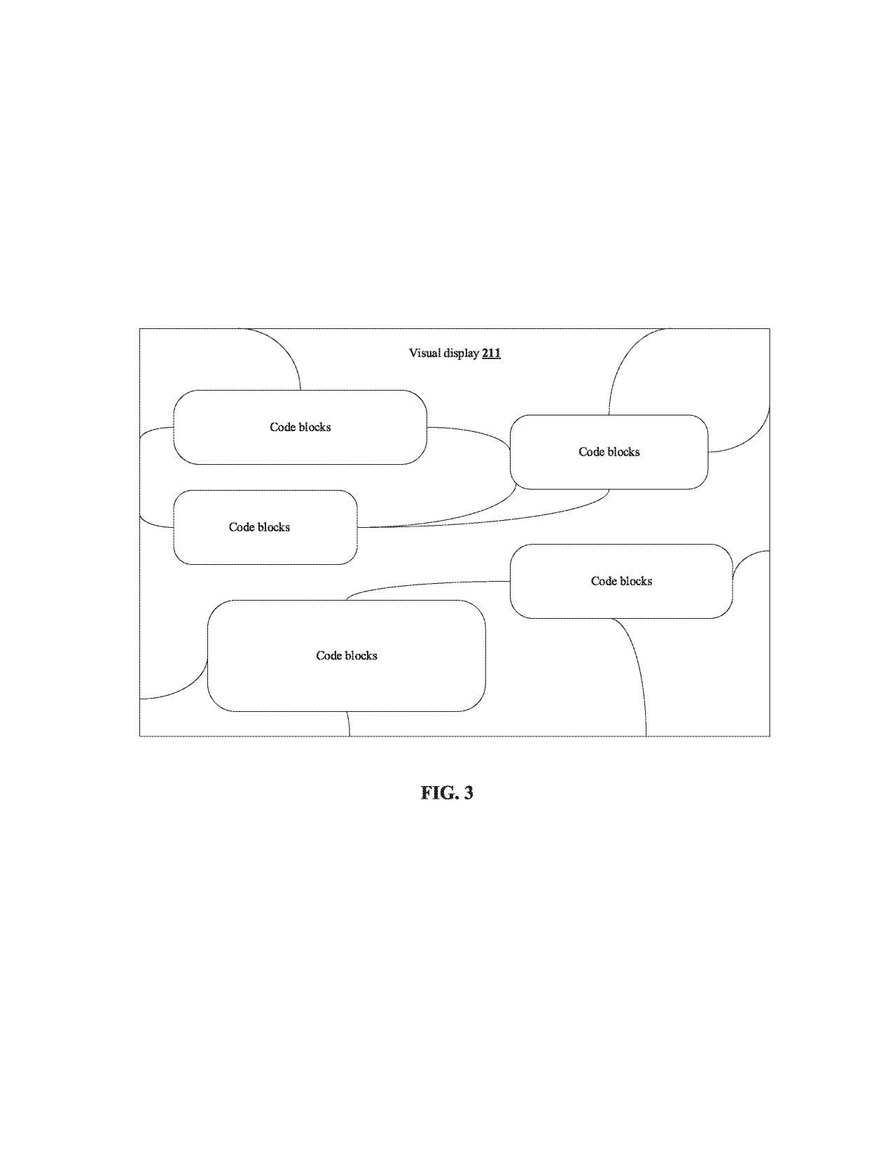

In an embodiment, upon representing the one or more RTL code objects, the visual display 211 may be configured to display the RTL directed graph. The visual display 211 may be an infinite canvas which may be configured to display the complete RTL directed graph. The visual display 211 may simultaneously allow visualization of multiple code blocks and corresponding interconnections (as illustrated in FIG. 3). The visual display 211 may also include an output interface configured to display debug information related to RTL code analysis and results (not shown in figure). In some embodiments, the visual display 211 and the output interface may be same. The visual display 211 and the output interface may also display results in a graphical format. In an embodiment, the visual display 211 may be configured to support zoom functionality for viewing details of individual code blocks or nodes. The zoom functionality may allow the user 203 to focus on specific areas of the RTL directed graph while preserving the ability to return to an overall view. The visual display 211 may also include user interface which may allow the user interactions within the visual display 211. The user interface allows the user 203 to group multiple code blocks into functional sections. The visual display 211 provides an integrated environment for real-time analysis and debugging of RTL designs. By enabling simultaneous visualization of structural elements, signal states, and dynamic behavior, the system improves design comprehension and accelerates error detection. These features collectively enhance the efficiency of verification workflows and reduce the time required for identifying and resolving design issues.

FIG. 3 shows an exemplary illustration of the directed graph, in accordance with an exemplary embodiment of the present disclosure.

In an embodiment, the graph converter 209 may convert an abstract syntax tree of the RTL code into the RTL DG. The RTL DG may be equivalent to the directed graph data structure in computer programming. The one or more signals/nodes of the one or more code blocks may be represented as the one or more vertex of the RTL DG equivalent to vertex of the directed graph data structure in computer programming.

In an embodiment, upon the conversion of the RTL code into the RTL DG. The RTL DG may be displayed to the designer on a screen. The screen may be considered as an infinite canvas which may allow designer to view complete code as illustrated in FIG. 3. The RTL code may include the one or more code blocks describing the operations of the one or more entities/components of the circuit. A code block out of the one or more code blocks of the RTL code may include a list of one or more signals used in the current code block to perform its corresponding operation. The one or more signals included in the code block may be known as nodes. The list of one or more signals included in the code block may be known as a node list.

The one or more signals/nodes in the RTL DG may be linked to each other through pointers. The link between the one or more signals/nodes may represent a link between one or more code blocks. The links between the one or more code blocks may have arrows to describe the direction of the data flow and the control/signal flow. Each code block of the one or more code blocks of the RTL DG may have a structure known as code block structure of the RTL DG.

As illustrated in the FIG. 3, the RTL code is displayed as it is to designer and the nodes are connected based on the code of the node. The code block in the one or more code blocks of the RTL code may also include a behavior description of the current code block. The behavior description may be defined by one or more RTL code lines defining connections between and operations performed on one or more signals/nodes included in the node list. The directed graph may be a visual display 211 of existing code as is in a dataflow/control flow manner, and not in a higher level abstraction.

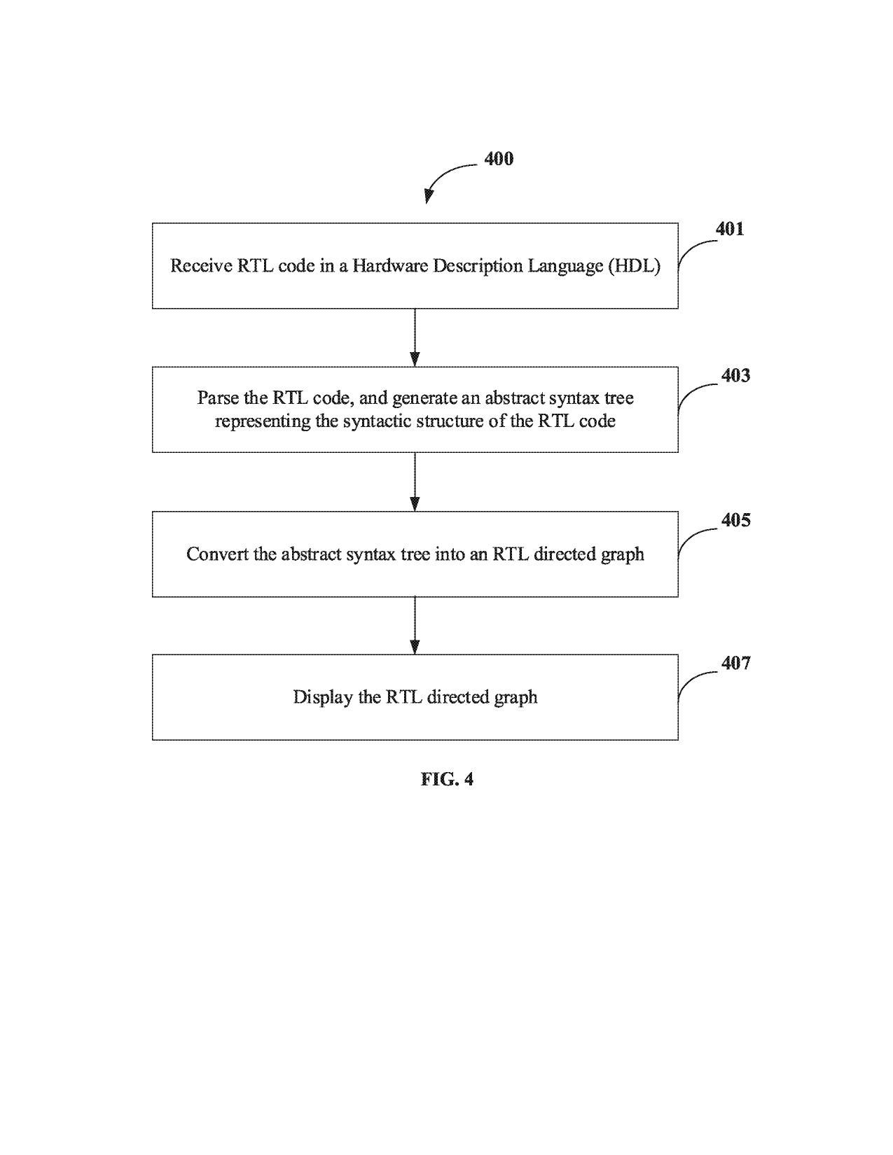

FIG. 4 is a flowchart illustrating a method of providing spatial display of Register Transfer Level (RTL) code on a visual display 211, in accordance with some embodiments of the present disclosure.

As illustrated in FIG. 4, the method 400 may include one or more blocks illustrating a method of providing spatial display of Register Transfer Level (RTL) code on a visual display 211, using the verification and debugging tool 201 illustrated in FIG. 2. The method 400 may be described in the general context of computer executable instructions. Generally, computer executable instructions can include routines, programs, objects, components, data structures, procedures, modules, and functions, which perform specific functions or implement specific abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 401, the method 400 includes receiving, by a processor of the verification and debugging tool 201, RTL code in a Hardware Description Language (HDL). The HDLs may include, at least one of Verilog and VHSIC Hardware Description Language (VHDL). Further, the processor may validate syntax of the RTL code.

At block 403, the method 400 includes parsing, by the processor, the RTL code, and generating an abstract syntax tree representing the syntactic structure of the RTL code.

At block 405, the method 400 includes converting, by the processor, the abstract syntax tree into an RTL directed graph. The RTL directed graph comprises plurality of code blocks. Each of the plurality of code blocks is represented as a node, and connections between the node indicate data flow in both upstream and downstream directions. Each node of the RTL directed graph may include at least one of a forward pointer to nodes for which the current node forms an input, and a backward pointer to nodes from which the current node receives an input. The processor may represent signals of the RTL code as vertices of the RTL directed graph. Further, the processor may provide one or more customizable display options for the RTL directed graph. The processor may also provide one or more customizable display options for the RTL directed graph. The one or more customizable display options may include, without limitation, at least one of color coding for different types of signals, adjustable node sizes, and selectable layers of data flow representation. Further, zoom functionality may be supported for viewing details of individual code blocks or nodes. The zoom functionality allows a user to focus on specific areas of the RTL directed graph while preserving the ability to return to an overall view. The RTL directed graph may be configured to display at least one of control flow and data flow. At least one of the control flow and the data flow is displayed in a visually distinguishable manner. The visual distinction between the control flow and the data flow may be obtained using one of different arrow styles or different colors.

At block 407, the method 400 includes displaying, by the processor, visual display 211 configured to display the RTL directed graph. Multiple code blocks and corresponding interconnections are visualized simultaneously. The processor may further display debug information related to RTL code analysis and results. A user interface allows user interactions within the visual display 211. The user interface may allow the user 203 to group multiple code blocks into functional sections.

### Computer System

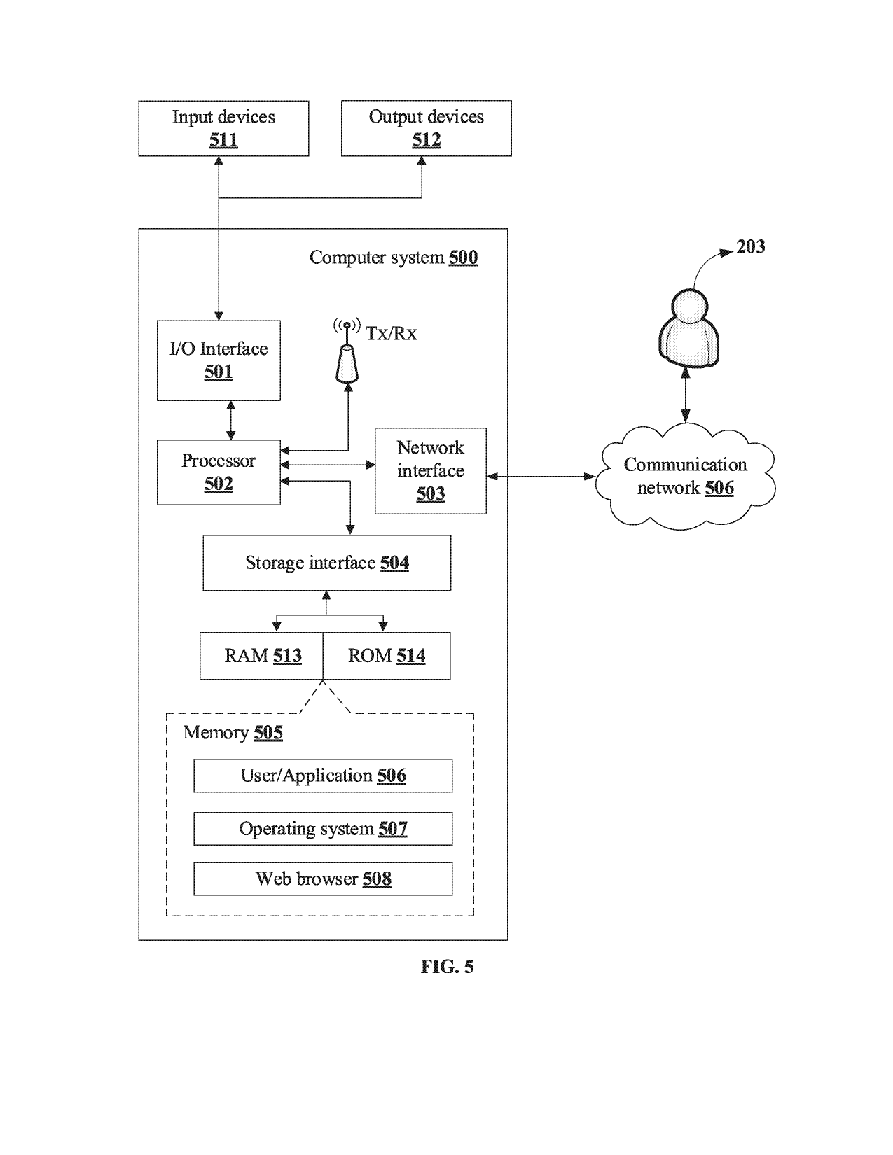

FIG. 5 illustrates a block diagram of an exemplary computer system 500 for implementing embodiments consistent with the present disclosure. In an embodiment, the computer system 500 may be a verification and debugging tool 201 illustrated in FIG. 2. The computer system 500 may include a central processing unit (“CPU” or “processor” or “memory controller”) 502. The processor 502 may comprise at least one data processor for executing program components for executing user- or system-generated business processes. A user may include a network manager, an application developer, a programmer, an organization, or any system/sub-system being operated parallelly to the computer system 500. The processor 502 may include specialized processing units such as integrated system (bus) controllers, memory controllers/memory management control units, floating point units, graphics processing units, digital signal processing units, etc.

The processor 502 may be disposed in communication with one or more Input/Output (I/O) devices (511 and 512) via I/O interface 50 1. The I/O interface 501 may employ communication protocols/methods such as, without limitation, audio, analog, digital, stereo, IEEE^{®}-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE^{®} 802.n /b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 501, the computer system 500 may communicate with one or more I/O devices 511 and 512.

In some embodiments, the processor 502 may be disposed in communication with a network 509 via a network interface 503. The network interface 503 may communicate with the network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE^{®} 802.11a/b/g/n/x, etc.

In an implementation, the preferred network 509 may be implemented as one of the several types of networks, such as intranet or Local Area Network (LAN) and such within the organization. The preferred network 509 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP) etc., to communicate with each other. Further, the network 509 may include a variety of network devices, including routers, bridges, RAN nodes, computing devices, storage devices, etc. Using the network interface 503 and the network 509, the computer system 500 may communicate with a user 203.

In some embodiments, the processor 502 may be disposed in communication with a memory 505 (e.g., RAM 513, ROM 514, etc. as shown in FIG. 6) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application interface 506, an operating system 507, a web browser 508, and the like. In some embodiments, computer system 500 may store user/application data 506, such as the data, variables, records, etc. as described in this invention. Such databases may be implemented as fault-tolerant, relational, scalable, secure databases such as Oracle® or Sybase®.

The operating system 507 may facilitate resource management and operation of the computer system 500. Examples of operating systems include, without limitation, APPLE^{®} MACINTOSH^{®} OS X^{®}, UNIX^{®}, UNIX-like system distributions (E.G., BERKELEY SOFTWARE DISTRIBUTION^{®} (BSD), FREEBSD^{®}, NETBSD^{®}, OPENBSD, etc.), LINUX^{®} DISTRIBUTIONS (E.G., RED HAT^{®}, UBUNTU^{®}, KUBUNTU^{®}, etc.), IBM^{®} OS/2^{®}, MICROSOFT^{®} WINDOWS^{®} (XP^{®}, VISTA^{®}/7/8, 10 etc.), APPLE^{®} IOS^{®}, GOOGLE ^{TM} ANDROID ^{TM}, BLACKBERRY^{®} OS, or the like.

The user interface 506 may facilitate display, execution, interaction, manipulation, or operation of program components through textual or graphical facilities. For example, the user interface 506 may provide computer interaction interface elements on a display system operatively connected to the computer system 500, such as cursors, icons, check boxes, menus, scrollers, windows, widgets, and the like. Further, Graphical User Interfaces (GUIs) may be employed, including, without limitation, APPLE^{®} MACINTOSH^{®} operating systems’ Aqua^{®}, IBM^{®} OS/2^{®}, MICROSOFT^{®} WINDOWS^{®} (e.g., Aero, Metro, etc.), web interface libraries (e.g., ActiveX^{®}, JAVA^{®}, JAVASCRIPT^{®}, AJAX, HTML, ADOBE^{®} FLASH^{®}, etc.), or the like.

The web browser 508 may be a hypertext viewing application. Secure web browsing may be provided using Secure Hypertext Transport Protocol (HTTPS), Secure Sockets Layer (SSL), Transport Layer Security (TLS), and the like. The web browsers 508 may utilize facilities such as AJAX, DHTML, ADOBE^{®} FLASH^{®}, JAVASCRIPT^{®}, JAVA^{®}, Application Programming Interfaces (APIs), and the like. Further, the computer system 500 may implement a mail RAN node stored program component. The mail RAN node may utilize facilities such as ASP, ACTIVEX^{®}, ANSI^{®} C++/C#, MICROSOFT^{®}, .NET, CGI SCRIPTS, JAVA^{®}, JAVASCRIPT^{®}, PERL^{®}, PHP, PYTHON^{®}, WEBOBJECTS^{®}, etc. The mail RAN node may utilize communication protocols such as Internet Message Access Protocol (IMAP), Messaging Application Programming Interface (MAPI), MICROSOFT^{®} exchange, Post Office Protocol (POP), Simple Mail Transfer Protocol (SMTP), or the like. In some embodiments, the computer system 500 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

In light of the technical advancements provided by the disclosed method, the claimed steps, as discussed above, are not routine, conventional, or not well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The terms "an embodiment", "embodiment", "embodiments", "the embodiment", "the embodiments", "one or more embodiments", "some embodiments", and "one embodiment" mean "one or more (but not all) embodiments of the invention(s)" unless expressly specified otherwise.

The terms "including", "comprising", “having” and variations thereof mean "including but not limited to", unless expressly specified otherwise.

The enumerated listing of items does not imply that any or all the items are mutually exclusive, unless expressly specified otherwise. The terms "a", "an" and "the" mean "one or more", unless expressly specified otherwise.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A verification and debugging tool for Register Transfer Level (RTL) code, the verification and debugging tool comprising:
an input interface configured to receive RTL code in a Hardware Description Languages (HDLs);
an RTL parser configured to:
parse the RTL code, and
generate an abstract syntax tree representing the structural relationships of the RTL code;
a graph converter configured to convert the abstract syntax tree into an RTL directed graph,
wherein the RTL directed graph comprises plurality of code blocks, and
wherein each of the plurality of code blocks is represented as a node and connections between nodes indicate data flow in at least one of upstream direction and downstream direction; and
a visual display configured to display the RTL directed graph, wherein the visual display simultaneously allows visualization of multiple code blocks and corresponding interconnections.

2. The verification and debugging tool of claim 1, wherein each of the plurality of code blocks comprises at least one of: a forward pointer to nodes for which current node forms an input; and a backward pointer to nodes from which the current node receives an input.

3. The verification and debugging tool of claim 1, wherein the graph converter is further configured to display signals of the RTL code as vertices of the RTL directed graph.

4. The verification and debugging tool of claim 1, further comprising:
an output interface configured to display debug information related to the RTL code analysis and results.

5. The verification and debugging tool of claim 4, wherein the output interface is configurable to show results in a graphical format.

6. The verification and debugging tool of claim 1, wherein the HDLs comprises at least one of Verilog and VHSIC Hardware Description Language (VHDL).

7. The verification and debugging tool of claim 1, wherein the graph converter is further configured to provide one or more customizable display options for the RTL directed graph.

8. The verification and debugging tool of claim 7, wherein the one or more customizable display options comprises at least one of: color coding for different types of signals, adjustable node sizes, and selectable layers of data flow representation.

9. The verification and debugging tool of claim 1, wherein the visual display is configured to support zoom functionality for viewing details of individual code blocks or nodes.

10. The verification and debugging tool of claim 9, wherein the zoom functionality allows a user to focus on specific areas of the RTL directed graph while preserving the ability to return to overall view.

11. The verification and debugging tool of claim 1, further comprises:
a user interface designed to allow user interactions within the visual display.

12. The verification and debugging tool of claim 11, wherein the user interface allows the user to group multiple code blocks into functional sections.

13. The verification and debugging tool of claim 1, wherein the RTL directed graph is configured to display at least one of control flow and data flow, wherein the at least one of the control flow and the data flow in displayed in visually distinguishable manner.

14. The verification and debugging tool of claim 13, wherein the visual distinction between the control flow and the data flow is obtained using one of different arrow styles or different colors.

15. A method of providing spatial display of Register Transfer Level (RTL) code on a visual display, the method comprising:
receiving RTL code in a Hardware Description Language (HDL);
parsing the RTL code, and generating an abstract syntax tree representing the syntactic structure of the RTL code;
converting the abstract syntax tree into an RTL directed graph,
wherein the RTL directed graph comprises plurality of code blocks,
wherein each of the plurality of code blocks is represented as a node, and
wherein connections between the node indicate data flow in both upstream and downstream directions;
displaying the RTL directed graph, wherein multiple code blocks and corresponding interconnections are visualized simultaneously.

16. A non-transitory computer readable medium including instructions stored thereon that when processed by at least one processor, cause a verification and debugging tool to perform operations comprising:
receiving RTL code in a Hardware Description Language (HDL);
parsing the RTL code, and generating an abstract syntax tree representing the syntactic structure of the RTL code;
converting the abstract syntax tree into an RTL directed graph,
wherein the RTL directed graph comprises plurality of code blocks,
wherein each of the plurality of code blocks is represented as a node, and
wherein connections between the node indicate data flow in both upstream and downstream directions;
displaying the RTL directed graph, wherein multiple code blocks and corresponding interconnections are visualized simultaneously.
